(19) United States
(12) Patent Application Publication
(10) Pub. No.: US 2003/0117321 A1
(43) Pub. Date: Jun. 26, 2003

(54) Embedded antennas for measuring the electrical properties of materials

(76) Inventors: Cynthia M. Furse, Salt Lake City, UT (US); Nitin Madan, Spokane, WA (US); Jeffrey D. Ward, Logan, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/190,747

(22) Filed: Jul. 8, 2002

Related U.S. Application Data
(60) Provisional application No. 60/303,558, filed on Jul. 7, 2001.
(60) Provisional application No. 60/369,006, filed on Apr. 1, 2002.

(51) Int. Cl. H01Q 1/38

(52) U.S. Cl. 343/700 MS

(57) ABSTRACT

A microstrip antenna that is capable of measuring electrical properties of materials, wherein the properties of relative permittivity and conductivity are utilized to determine information regarding the materials being probed such as quality, composition, presence, and moisture content, wherein the microstrip antenna conforms to a variety of surfaces, operates in hazardous environments, is manufactured utilizing printed circuit board techniques, and makes measurements through direct contact with or being adjacent to the material being probed.

### CROSS REFERENCE TO RELATED APPLICATIONS

This document claims priority to, and incorporates by reference all of the subject matter included in the provisional patent application filed on Jul. 7, 2001, having serial No. 60/303,558, and in the provisional patent application filed on Apr. 1, 2002, having serial No. 60/369,006.

### BACKGROUND

1. The Field Of the Invention

This invention relates generally to measuring electrical properties of materials utilizing antennas. More specifically, the invention relates to utilizing a microstrip antenna as a sensor or probe for measuring the relative permittivity and the electrical conductivity of materials in order to obtain useful information regarding the materials, and for also using the same microstrip antenna to communicate the sensor data.

2. Background of the Invention

It is known that different materials have different electrical properties. For example, materials with a high water content will have a high permittivity value. Furthermore, materials having large amounts of water, salts, minerals, etc. generally have a high conductivity value. In contrast, materials containing fats and other good electrical insulators have low conductivity and generally low relative permittivity values as well. Accordingly, by measuring the electrical properties of a material, it is possible to determine what a material is made of, how moist it is, and the quantity of fat, salt, sugar, etc. the material contains.

There are numerous applications for sensors and probes that can determine the relative permittivity and electrical conductivity of materials in which they come in contact with or are disposed nearby. The wide variety of applications also demonstrates a need within the industry to provide a probe design that is capable of obtaining the desired information. Some examples of these widely disparate applications include moisture content of soil, grain, wood, fat content of meat and dairy products, properties of various plasmas, electrical properties of human tissue, ripeness and quality of produce, geological mapping for geophysical prospecting, and numerous measurements of chemical composition.

The problem in the industry is finding a probe that is capable of providing all of the desired information in a relatively non-invasive manner, and economically. Some probe designs for moisture measurement require significant physical interaction with the material being measured. State of the art probe designs include the three-prong fork, a single prong or monopole probe, a square or circular waveguide, a horn antenna, a coaxial probe, and flat plates or other capacitor type structures that are filled with the material being probed.

Many of these probes are utilized in commercial applications today. The electronics associated with these probes measure change of resonant frequency, real, imaginary, or complex impedance, and/or reflection coefficient that are all dependent upon the electrical properties of the material surrounding the probe. As stated previously, a common disadvantage of these probes is that they must protrude into or contain a sample of the material under investigation. Another matter to consider is that there are many ways of measuring relative permittivity and conductivity, but these other ways can change electromagnetic waves.

The present invention utilizes probes that are constructed of microstrip antennas. Microstrip antennas are known in the art, but it is helpful to review their properties in order to understand new application and new configurations. A microstrip antenna is formed from a thin sheet of low-loss insulating material, and is often referred to as the dielectric substrate. One side of the substrate is completely covered with metal and functions as a ground plane. The other side of the substrate is partly metallized. A circuit and/or antenna patch can be printed or etched thereon. Components can be included in the circuit either by implanting lumped components or by realizing them directly within the circuit.

A microstrip patch antenna uses a microstrip structure to realize an antenna. When a microstrip patch antenna is fed with a signal at an appropriate frequency, the antenna radiates as the fields at the edge of the patch undergo fringing. Microstrip antennas are low-profile, conformal to planar and non-planar surfaces, simple, and inexpensive to manufacture when using modern printed-circuit board technology, mechanically robust when mounted on rigid surfaces, and very versatile in terms of resonant frequency, polarization, radiation patterns and impedance.

There are other advantageous characteristics of the patch antenna that become important to the present invention. A simple two-dimensional circuit topology facilitates compact design possibilities. Printed circuits can be used to manufacture them, which can lead to important reductions in size, especially when the dielectric substrate permittivity is high. Large scale fabrication is possible, which reduces the manufacturing cost per unit. It is also easy to insert a wide variety of active or passive lumped components in a microstrip antenna circuit. Finally, all the components are rigidly and permanently mounted on the substrate which increases reliability by eliminating the need for less reliable transitions and connectors.

FIG. 1A shows that a patch antenna 2 comprises a ground plane 4, a layer of insulation 6, and an antenna structure 8 disposed on top of the insulation. There is also a connection 7 between the antenna structure 8 and the ground plane 4, and a feed point 9. A traditional patch antenna is a square, such as a square piece of conductive material that is disposed on a printed circuit board. As a probe, it operates adequately because its fields fringe over the edge of the conductive antenna material, but it is generally too big to be of any interest for most applications.

FIG. 1B is provided as a profile cut-away view of the patch antenna of FIG. 1A.

It would be an advantage over the prior art to provide a system for measuring electrical properties of materials that was less invasive in the type of contact necessary for the probe to make its measurements. It would be a further advantage to provide a system that is more economical, easier to use, relatively small, very durable, easily manufacturable, and capable of conforming to various size and space requirements where it is desirable to use the sensors.

The applications described above teach a single use of a microstrip antenna. This means that the antenna is either being used to receive data, or transmit data. It would be another advantage over the prior art to provide a sensor system that could use a single antenna both for collection of data, and for transmission of that data after it has been collected.

The background above also describes the simplest of designs for the antenna itself. It would be another advantage over the prior art to utilize different designs for more specialized purposes, including both planar and non-planar shapes.

### SUMMARY OF INVENTION

It is an object of the present invention to provide a sensor for determining the electrical properties of materials, wherein the sensor is less invasive than existing sensor designs.

It is another object to provide a sensor that performs at least as well as existing sensor designs.

It is another object to provide a sensor that is capable of operation while conforming to desired space limitations, thereby enabling use in a wide range of locations.

It is another object to provide a sensor that is capable of being disposed flush against a surface to enable use under environmentally harsh conditions.

It is another object to provide a sensor that is capable of conforming to non-planar surfaces to obtain benefits not available to the planar antenna design.

It is another object to provide a sensor that is capable of making measurements when the sensor is adjacent to the material, and not making direct contact.

It is another object to provide a sensor that can both gather and transmit data.

It is another object to provide a sensor that is capable of replacing a dipole antenna in plasma applications in the upper atmosphere.

In a preferred embodiment, the present invention is a microstrip antenna that is capable of measuring electrical properties of materials, wherein the properties of relative permittivity and conductivity are utilized to determine information regarding the materials being probed such as quality, composition, presence, and moisture content, wherein the microstrip antenna conforms to a variety of surfaces, operates in hazardous environments, is manufactured utilizing printed circuit board techniques, and makes measurements through direct contact with or being adjacent to the material being probed.

In a first aspect of the invention, a sample of the material being tested can be disposed on the microstrip antenna, thereby altering the impedance of the sensor, resonant frequencies of the sensor, and other properties, and enabling measurement of the material being tested.

In a second aspect, the microstrip antenna can be manufactured utilizing printed circuit board techniques that provide durable, inexpensive, and low-profile designs.

In a third aspect of the invention, a polarized microstrip antenna is utilized as the sensor.

In a fourth aspect of the invention, various shapes are used for the microstrip antenna, including spiral, serpentine, capacitive gap, waffle, and fractal.

In a fifth aspect of the invention, the microstrip antenna is disposed adjacent to but not in contact with the material being measured.

In a sixth aspect of the invention, the microstrip antenna is utilized in “flow-through” applications wherein the material is moving past the sensor, and readings are continuously collected.

In a seventh aspect of the invention, the microstrip antenna is utilized to measure plasma in various environments, as well as materials in caustic, radioactive, and otherwise hazardous environments.

In an eighth aspect of the invention, the microstrip antenna operates as a two-way communication device, being capable of operating in a data collection mode, and in a data transmission mode.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1A is a top elevational view of a square patch antenna.

FIG. 1B is a profile cut-away view of the square patch antenna of FIG. 1A.

FIG. 2A is cut-away profile view of a spiral microstrip antenna structure.

FIG. 2B is a top view of a spiral microstrip antenna structure of FIG. 2A.

FIG. 3 is a top elevational view of a serpentine microstrip antenna structure.

FIG. 4 is a top elevational view of an antenna structure having a capacitive gap.

FIG. 5 is a top elevational view of a waffle microstrip antenna structure.

FIG. 6 is a top elevational view of a fractal microstrip antenna structure.

FIG. 7 is a top elevational view of a microstrip antenna structure taken from an ortho-planar spring design.

FIG. 8 is a top elevational view of a microstrip antenna structure taken from an ortho-planar spring design.

FIG. 9 is a top elevational view of a microstrip antenna structure taken from an ortho-planar spring design.

FIG. 10 is a top elevational view of a microstrip antenna structure taken from an ortho-planar spring design.

FIG. 11 is a top elevational view of a microstrip antenna structure taken from an ortho-planar spring design.

FIG. 12 is a top elevational view of a microstrip antenna structure taken from an ortho-planar spring design.

FIG. 13 is a cross-sectional view of a non-planar microstrip antenna.

FIG. 14 is a cross-sectional view of a non-planar microstrip antenna that includes non-planar structures on a surface thereof.

FIG. 15 is a top elevational view of a substrate comprised of different dielectric materials.

FIG. 16 is a cross-sectional view of a stacked antenna, comprised of two different microstrip antenna shapes.

FIG. 17 is a graph of a Yee cell for the FDTD model.

FIG. 18 is a time line used for the FDTD model.

FIG. 19 is a list of the final FDTD model equations.

FIG. 20 is a cross-sectional view of two stacked microstrip patch antennas that compensate for the Debye effect.

FIG. 21 is a block diagram of a plasma impedance probe constructed from microstrip patch antennas

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a microstrip antenna. Microstrip antennas have not been previously utilized as sensors for taking electrical measurements. Their use has generally been restricted to communications, and as on-board inductors. Thus, it is one aspect of the invention to utilize microstrip antennas in a sensor capacity.

Construction of a microstrip antenna is relatively simple in the presently preferred embodiment. A microstrip antenna 10 is similar to a patch antenna described previously. As shown in FIG. 2A, the microstrip antenna comprises a ground plane 12, a layer of insulating material 14, and an antenna structure 16 disposed on top of the insulating material. The microstrip antenna also includes a connection 18 between the ground plane 12 and the antenna structure 16, and a connection 20 to a signal source or signal detector. FIG. 2B is a top elevational view of the microstrip antenna 10, wherein the antenna structure 16 in this particular figure is a spiral. The insulating material 14 can be any material that is appropriate for the application, such as a ceramic, silicon, TEFLON(TM), etc.

It is noted that the spiral microstrip antenna shown in FIGS. 2A and 2B appears to more efficient than the other designs, at least initially. However, it should be noted that the spiral structure does not have to be a circular spiral as shown. The spiral can be square, rectangular, triangular, or any other polygon shape.

FIG. 3 is a top elevational view of an alternative embodiment of an antenna structure that can be disposed on top of the insulating material. In FIG. 3, the shape of the antenna structure 30 is serpentine. The dimensions shown are only an example, and should not be considered to be limiting.

FIG. 4 is a top elevational view of another alternative embodiment of an antenna structure that can be disposed on top of the insulating material. In FIG. 4, the antenna structure 40 has a capacitive gap. In this figure, the antenna structure 40 includes a connection 42 between a ground plane (not shown) and a first part 44 of the antenna structure 40, and a second connection 48 to a signal source or signal detector in the second part 50.

While FIGS. 2A, 2B, 3 and 4 each show a different shape for an antenna structure, it should be remembered that there are other similar shapes that can also provide similar operating characteristics, and should be considered within the scope of this disclosure. These designs include, for example, various ellipsoids and polygons in microstrip format. The direction of the spiral shape can also be reversed if desired.

It is useful to describe some other microstrip antenna designs that are not as easy to visualize as ellipsoids and polygons. FIG. 5 describes a waffle antenna structure 60. A waffle antenna has a grid-like structure with a plurality of apertures 62 being made in a metallic sheet 64. It should be considered to be within the scope of this invention that the specific outline 66 of the metallic sheet 64 could be varied in order to achieve some desired effect. The outline 66 shown here is a square.

FIG. 6 is an illustration of another microstrip antenna design. This is only one example of a fractal microstrip antenna 70. A fractal microstrip antenna repeats some shape within the outline 72 of the microstrip antenna. In this example, triangular shapes have been cut out of, and thus left in a metallic sheet 74. The outline 76 has been left as a square, but could be any desired shape.

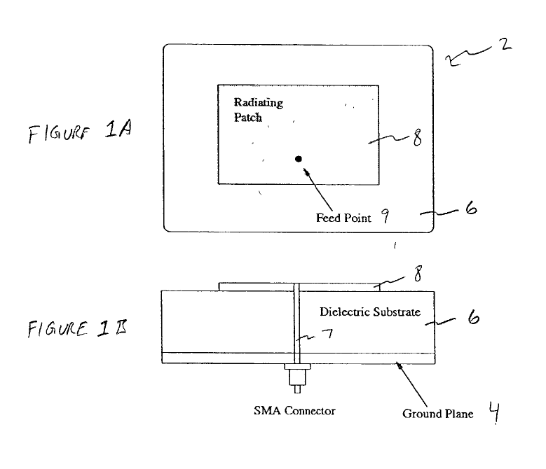

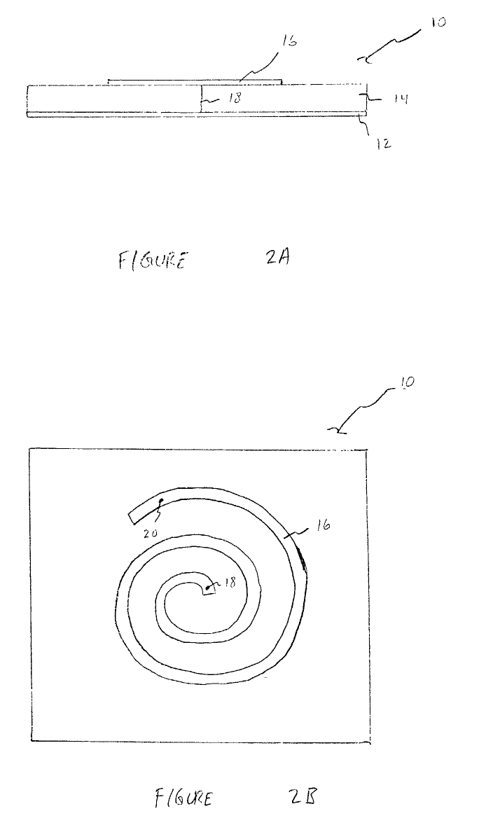

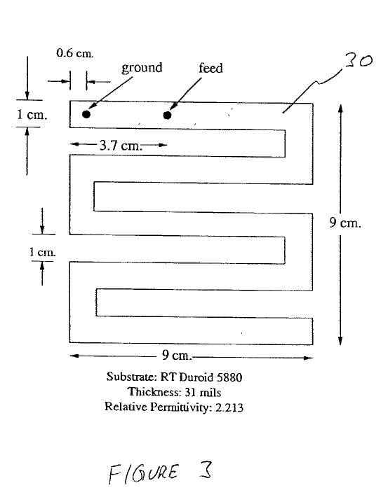

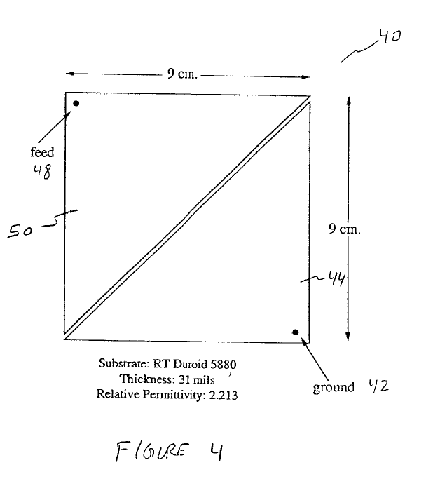

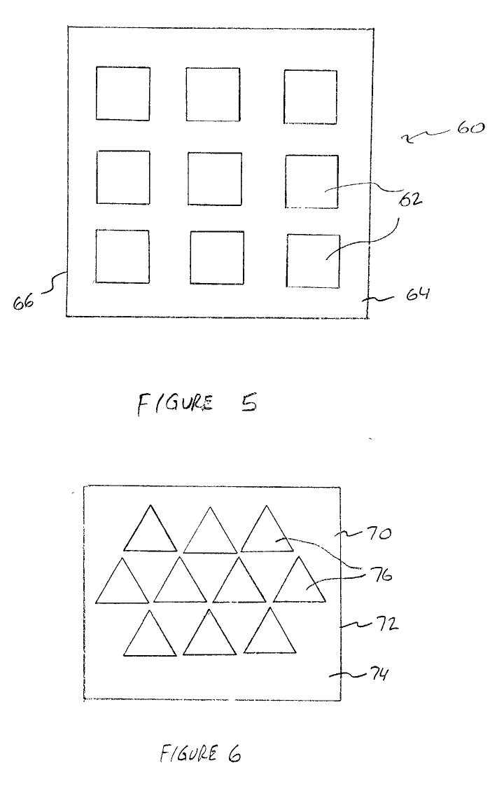

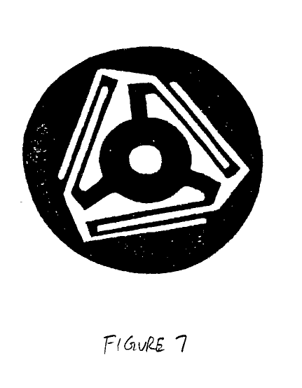

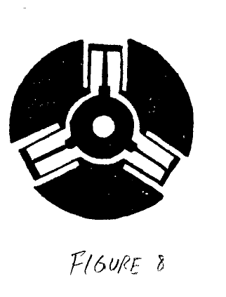

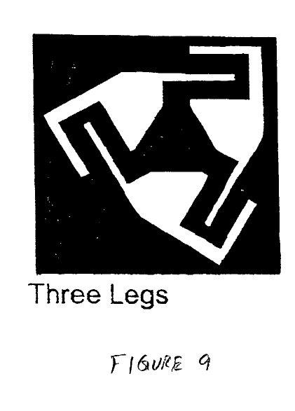

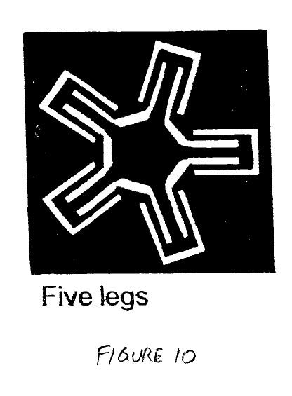

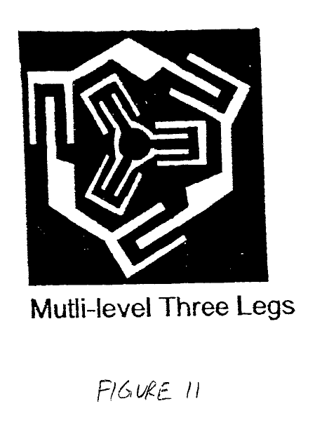

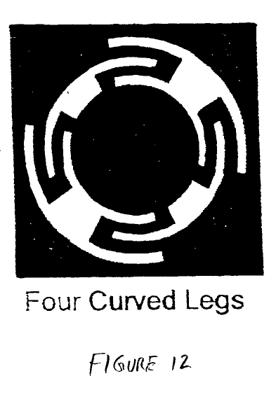

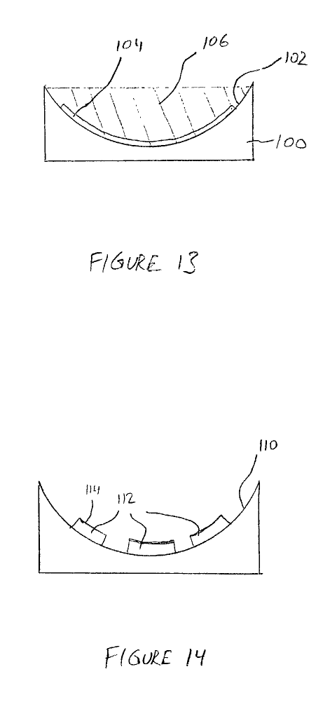

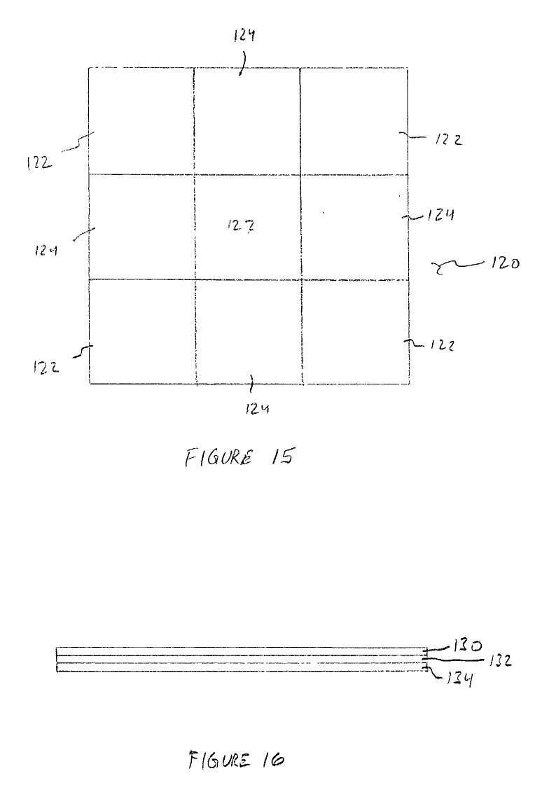

The shapes used for the microstrips antennas have been illustrated in FIGS. 1 through 4 as being relatively simple. FIGS. 5 and 6 are shown as being progressively more complex. The complexity of the microstrip can be increased even further. For example, the inventors have investigated the use of antenna designs from structures that are not created to be antennas. Specifically, FIGS. 7, 8, 9, 10, 11, and 12 all illustrate top views of more complex microstrip antenna designs. What is interesting to note is that these designs are taken from ortho-planar springs. And yet each of these designs provides a unique structure that can be used in a conventional two-dimensional antenna design, as well as a three-dimensional design because they are designed to be flexible in the z-axis. Thus, these antenna designs could easily be used in a non-planar microstrip antenna.

Another concept that teaches a novel aspect of the invention is the use of a non-planar substrate. FIG. 13 shows a substrate 100 that has a non-planar surface 102. The antenna 104 is disposed on the non-planar surface 102. In this figure, the non-planar surface 102 is an arcuate surface. A superstrate 106 could be disposed within the depression of the arcuate non-planar surface 102. The superstrate 106 is a filler material that could also be used to provide advantageous characteristics to the microstrip antenna.

It is another aspect of the invention that the non-planar surface of a substrate could have raised or lowered structures on it, and on which the antenna would also be disposed. These structures could be uniform or non-uniform. For example, consider the non-planar surface 110 shown in a cross-sectional view in FIG. 14. The non-planar surface 110 comprises an arcuate surface defining a first surface that has a plurality of raised posts 112. These raised posts 112 define a second arcuate surface. An antenna could be disposed on the raised posts 112 as long as they are coupled together, and a ground plane could be disposed on the non-planar surface 110.

Some of the purposes behind using non-planar surfaces for microstrip antennas are, for example, the ability to focus energy. The microstrip antenna can also be made smaller. Advantageously, the microstrip antennas can be to conform to a particular object, such as the outside of a sounding rocket, or within the confining space of a probe.

There are other changes that can be made in microstrip antennas to achieve different attributes. For example, consider FIG. 15 which is a top view of a substrate 120 for a microstrip antenna. The substrate 120 is made of a checkerboard of materials. One of the materials in the checkerboard pattern has a high dielectric constant, and the other material has a lower dielectric constant. This difference in dielectric constants affects the properties of a resulting waveform from the microstrip antenna.

This same type of affect can also be achieved by disposing apertures, such as holes or slots, in the ground plane of a microstrip antenna.

Even more surprisingly, the inventors are stacking microstrip antenna shapes. In the state of the art, suggesting to stack antennas would bring to mind a first solid ground plane, a first microstrip antenna shape disposed thereon, then a second solid ground plane, and a second microstrip shape on top of that. However, the present invention teaches using a microstrip antenna shape as the ground plane.

Thus, consider FIG. 16 which is a cross-sectional view of a microstrip antenna, wherein a first layer is, for example, a serpentine microstrip antenna shape 130. The second layer is a dielectric material 132. The third layer is a spiral microstrip antenna shape 134. Either the serpentine microstrip antenna 130 or the spiral microstrip antenna 134 would be utilized as the ground plane, while the other antenna would be used as the sensor.

It is an aspect of the present invention that any microstrip antenna design could be substituted for the serpentine and spiral shapes shown in FIG. 16. Thus, this example should not be considered to be limiting.

What is not yet apparent from the description of FIG. 16 is that this advantageous configuration provides several surprising benefits. First, it should be realized that FIG. 16 is a stacked antenna. The inventors have determined that there are essentially three reasons for stacking in the present invention. First, the microstrip antennas can be made smaller as already discussed. Second, the stacked antennas can operate in a wide band or broadband configuration. Third, the microstrip antennas can operate in a dual band configuration.

An example of the dual band configuration illustrates the tremendous advantage of this design. Consider a stacked microstrip antenna. The first microstrip antenna shape in the antenna can be tuned for a specific frequency that is particularly useful in a sensing mode. The second microstrip antenna shape in the antenna would be operating as a ground plane.

Most advantageously, the roles of the microstrip antenna shapes would then be reversed. But instead of using the second microstrip antenna shape as a sensor, it could also be used as a transmitter that is tuned to a different frequency than the first microstrip antenna shape. The transmission frequency of the second microstrip antenna shape would be selected so as to be optimized for a remote receiver. Thus, the stacked microstrip antenna becomes a sensor tuned to a first frequency, and a transmitter tuned to a second frequency, and would thus be capable not only of collecting data, but then transmitting that data to some remote location. Similarly, the first antenna could be tuned to sensing a first material or property, and the second antenna could be tuned to sensing a second material or property. Thus, the combinations of materials or properties that the antennas can be tuned to monitor or detect are increased through stacking.

There are other possible reasons for giving a, sensor the ability to communicate. For example, a user might want to update instructions that are stored with the sensor. A user might want to tune a frequency of a sensor. A user might also want to turn off the sensor in order to conserve battery power. The sensor could be programmed to automatically turn itself back on within a programmed amount of time after being turned off.

The other aspects of the invention could be applied to the stacked microstrip antenna as well. For example, the stacked microstrip antennas could be disposed in a non-planar configuration.

Having described examples of the physical structure of the microstrip antenna sensors that are taught by the present invention, it is useful to discuss their applications. Specific applications for sensors that are capable of detecting relative permittivity and conductivity of materials include determining ripeness of a fruit or vegetable, and moisture content of foods.

For example, moisture measurements have many applications in agriculture, food storage, manufacturing processes of organic and inorganic materials, wood drying processes, construction material assessment and curing of concrete, glue, polymers, coatings, etc. Applications also include food quality and composition monitoring, salinity assessment, soil fertilization levels, agriculture testing and harvesting, and measurement of biological materials for research and testing.

More diverse applications include security or monitoring. For example, it is possible to determine if a person recently walked through a door. It is also possible to determine if a patient is in a wheelchair, or if a detected object in the chair is something else such as a briefcase.

Consider the automotive industry. The awareness of safety issues involved in the use of air bags has become very important because they can save lives, or take them. There is great danger involved if a child is sitting in a seat where an air bag can deploy. Despite warning, parents will still put infants and children in these seats. The sensors of the present invention could be used to determine the nature of the person sitting in the car seat, and not deploy the air bag if the object detected in the seat is not an adult or sufficiently large child.

It is of particular importance to characterize some of the measurements that can be made in order to recognize the benefits of the present invention. In the first scenario, measurements can be taken using the microstrip antennas of the present invention where the sensor is fixed in relation to the material being monitored or probed. In the second scenario, the sensor is moving, and the medium is relatively fixed. In the third scenario, both the sensor and the medium are dynamic, and able to move relative to each other.

An example of the first scenario where the sensor is fixed relative to the medium being probed is when a conveyor belt is carrying material, and the sensor is disposed underneath. The microstrip antenna sensor can not only be used to detect the presence or objects, but count them, and possibly determine characteristics thereof.

Another example of a flow-through application is where a sensor is disposed along a wall of a chute carrying a material. The microstrip antenna sensor is advantageously disposed against the sides of the wall so, as not to interfere with movement therethrough.

An example of the second scenario is in a medical application. Consider a sensor that is ingested by an animal. The sensor travels through the digestive tract of the animal, providing information on the physical condition of the animal. But this example should not be considered limiting. There are certainly other applications that require a mobile sensor that can report on the surrounding environment through which it is passing.

An example of the third scenario is included in the application of plasma detection and characterization. Microstrip antennas of the present invention bring new capabilities to monitoring ionospheric plasma in the upper atmosphere, and industrial plasma. When immersed in a plasma of either origin, the microstrip antennas are capable of simultaneously measuring multiple characteristics that cannot be simultaneously measured with current state of the art devices. These characteristics include plasma density, collision frequency, temperature, composition, and magnetic field strength. Being capable of determining collision frequency is a new application of the present invention.

Regarding ionospheric plasmas, when disposed on the surface of a space vehicle such as a sounding rocket used in upper atmospheric experiments, the microstrip sensor can measure electrical properties of ionospheric plasma in the atmosphere during its ascent. The main purpose is to measure, characterize and map the distinct compositional layers of the atmosphere. This data can be particularly useful for space flight, upper atmospheric military and commercial travel, upper atmospheric wind analysis, solar flare analysis, lightning detection and analysis, flight planning for commercial and military aircraft, weather analysis and prediction, communications, space-based weapons systems, and other applications that require accurate modeling of the upper atmosphere.

It is noted that it is the current practice in ionospheric plasma study to use a dipole antenna, in which two rods are disposed on the outside of a vehicle. Utilizing the microstrip antenna of the present invention enables measurements to be taken during takeoff and landing of an aircraft, as opposed to only using it at cruising speed. One advantage is being able to avoid, having to deploy a sensor in flight, and then store it for landing. This enables data to be accumulated during all phases of flight, and not just during the cruising stage of a flight.

When used as a plasma probe in the atmosphere, it is important to remember that the microstrip antenna sensor must be designed to operate with a resonant frequency that is well above the plasma frequency. It has also been determined that the size of the microstrip antenna sensor has a great affect on sensitivity.

Because plasma is comprised of charged particles, any movement of these particles will have a direct effect on electromagnetic waves. This phenomenon is incorporated into the current term in Ampere's equation. A permittivity matrix has been developed that is applicable where a conductive term is known. But if the conductive term is not known, complex integrals with singularity have to be evaluated.

Instead of analytically solving the plasma equations for the conductivity term, they are incorporated into a Finite Difference Time Domain (FDTD) model. This makes it possible to expand the model's flexibility. Taking the conservation of momentum equations to find the average velocity, and the equations for the conservation of density to find the density, it is possible to determine the current, and in turn its effect on the electric and magnetic fields.

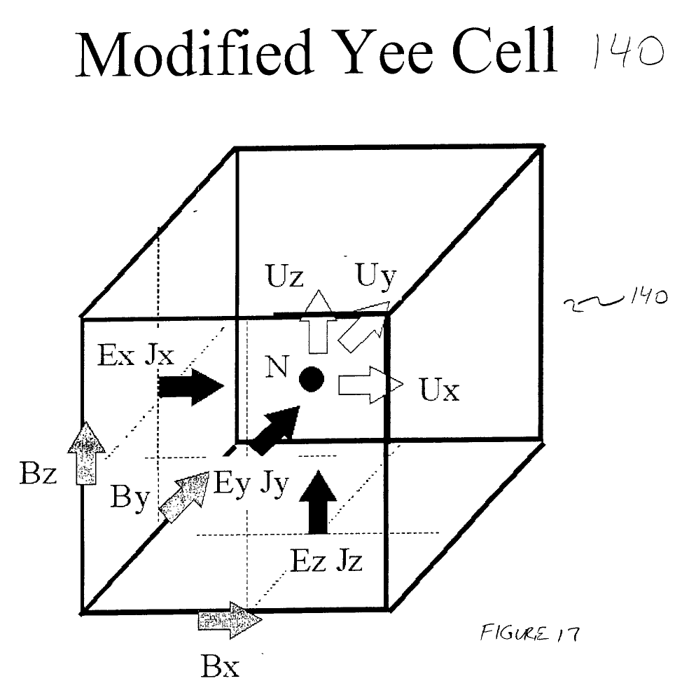

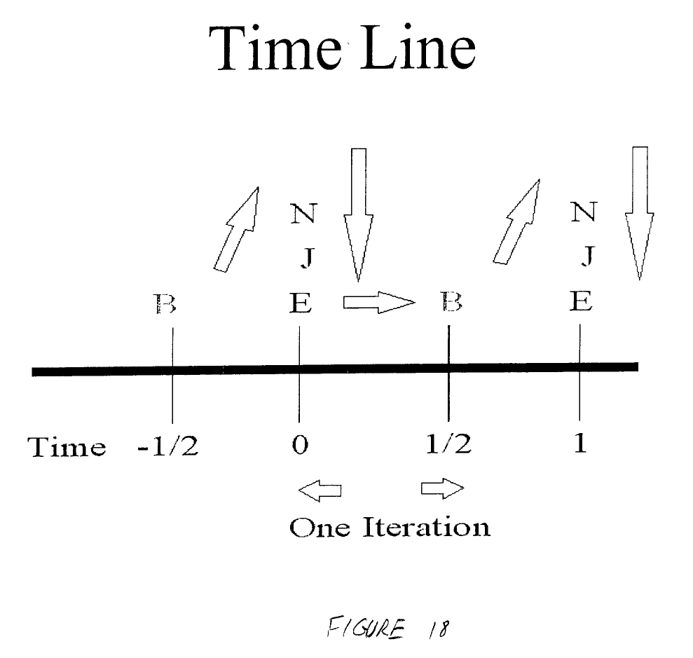

Like all FDTD models, it is necessary to define a Yee cell. As shown in FIG. 17, the electric and magnetic fields are the same as the conventional Yee cell. The current is at the same location as the electric field to simplify calculations. The density is placed at the center so that the whole cell can be modeled as one partial. The velocity is placed at the center so that it can directly effect the representation of particles in the cell.

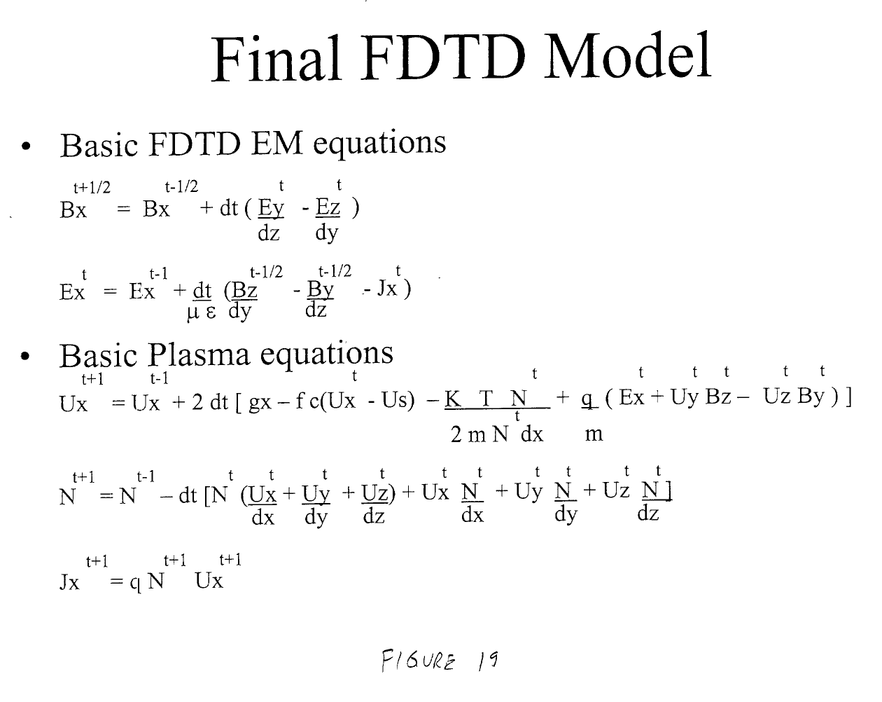

After the Yee cell is defined, the time line is generated as shown in FIG. 18. The electric and magnetic fields are calculated for the current time step in the same manner as other FDTD models. The average velocity and density are predicted at the next time step given the current values. Once the velocity and density are known, the current can be found, which is needed to determine the electric field.

The final FDTD model is shown by the equations shown in FIG. 19. The magnetic field is dependent upon the electric field. The electric field is dependent upon the magnetic field and the current. The velocity is dependent upon past velocities and densities, as well as the electric and magnetic fields, temperature, and gravity.

At this point, the plasma becomes anisotropic, due to dependency of the predicted value for the X directed velocity being dependent upon the Y and the Z velocities at the current time. Next, the density is dependent upon past densities and velocities. Finally, the current relies on the velocity and the density.

Like all simulations, boundary conditions must be applied. In this case, the electric field, the average velocity, and the density all need values that are unobtainable. Because the only value that is anisotropic is the velocity, the model uses the retarded time absorbing boundaries on the electric field and density terms. When the time absorbing boundary conditions are applied to the velocity wave, which travels slower and decreases faster than the electric wave, the results were mixed. It was determined that using a 20 to 30 cell buffer at the edge, and by controlling the hybrid frequency and resolution, it became possible to decrease the noise and instability for several thousand iterations. Future models will use perfectly matched layers.

In order to understand the affects of plasma, it is necessary to establish a baseline reading. The different modes of the microstrip antenna cause variations in impedance.

As a whole, plasma can be treated as a quasi-neutral fluid. However, as the measurement size decreases, there are so few plasma particles per unit that the assumptions in the fluid model break down, and the plasma begins to behave like individual particles.

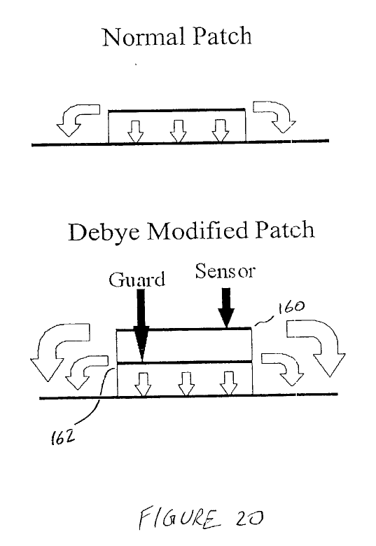

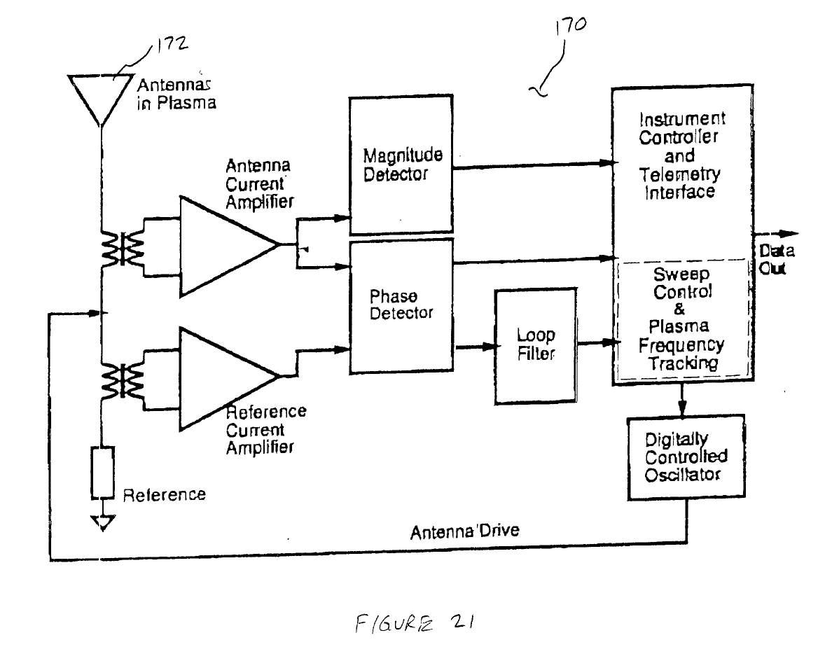

Because the strongest fields, and therefore the sensitivity of a microstrip antenna are near it's surface, the Debye effect cannot be ignored. Accordingly, two microstrip patch antennas are stacked on top of each other as shown in FIG. 20. Both antennas are fed with the same potential and the measurements are taken off the top microstrip patch antenna. The bottom microstrip patch antenna will force the field lines of the top microstrip patch antenna to travel thru the plasma a greater distance, and enable the plasma to be treated as quasi-neutral, and thus as a fluid, enabling the validity of this FDTD model.

Much like a dipole antenna, the change in plasma frequency causes a shift in a peak, and increases the Q of the imaginary impedance, while increasing the magnitude of the real part at the same time. Unlike all other sensors, the change in collision frequency doesn't affect the magnitude of the impedance. Instead, it causes a frequency shift.

Accordingly, there is now a way to model hot, magnetized, ionospheric plasma without performing the complex integrations required to find the relative permittivity.

A block diagram of a plasma impedance probe construction from microstrip patch antennas is shown in FIG. 21.

For industrial plasmas, the main applications are for measuring, characterizing, and dynamically controlling plasmas used for various coating, hardening, and other surface modification processes for materials such as metals, plastics, ceramics, cermets and the like. The antennas may also be useful for similar measurement and control of other industrial processes where plasmas are present such as lighting, nuclear power, and in other plasma environments. Using the microstrip antenna in plasmas would also be useful for the design, set-up, calibration and/or certification of a wide variety of plasma-producing equipment and products.

One of the unique aspects of using a microstrip antenna as a sensor in both ionospheric and industrial plasma applications is the ability to sense various characteristics of the plasma right on the desired surface as opposed to other sensing methods, such as dipole antennas for ionospheric plasmas, and needle-like probes for industrial plasmas. These probes are typically above the surface of interest. In some circumstances, even the thickness of a small needle-probe can have a large affect on plasma measurements. Thus, it is necessary to infer what is actually happening at the surface of interest rather measuring it directly as with the present invention.

Not only can the invasive presence materially alter the characteristics of the plasma being probed by disturbing or interacting with the plasma, state of the art plasma probes can artificially shift the measurements. In the case of industrial plasmas, probe interaction with the plasma can negatively impact the plasma process in the vicinity of the probe, thereby affecting quality of products being manufactured.

For industrial applications, the ability to measure plasma properties directly on a process surface has the distinct advantage of enabling very accurate measurements that not only characterize the plasma process, but also do so in a real-time environment that can be instantaneously used in a dynamic feed-back loop to actively control the parameters of the plasma. In an application such as semiconductor processing where one bad wafer can cost tens of thousands of dollars, the ability to dynamically monitor and control a plasma process can have significant economic and competitive advantages.

One of the challenges facing the utilization of the microstrip antennas of the present invention for its intended uses is the development of systems for correlating the measured electrical properties to useful physical properties of the materials being measured. Such a correlation will enable one-to-one correspondence between electrical properties and physical properties. It is most likely that systems used for correlation of waveguide data can be adapted for this purpose. In other words, existing correlation data might only require relatively small adaptations to be used with the improved microstrip antennas of the present invention.

There are other sensing scenarios that might include features of all three monitoring scenarios. Consider a hand-held device that has a sensor end that is held against a material, such as wood or soil, as moisture content or many other properties are measured. A farmer could use the hand-held device to determine the best time for harvesting. Similarly, the consumer can take the hand-held device to a store and use it to determine which produce is ripe, under-ripe, or over-ripe.

The low cost of the microstrip antenna sensor also enables it to be disposed on or near materials, even if the sensor is eventually destroyed. For example, the sensor can be embedded within the material itself up until the time that the material is ready for further processing, as determined by the sensor, and communicated by wire or wireless transmission of that data.

It is envisioned that an impedance measuring device such as a network analyzer, impedance bridge, time domain reflectometer, frequency domain reflectometer, or other similar device will be coupled to the microstrip antenna sensor. It is known that the presence of the material changes, among other things, the impedance of the sensor. The impedance is defined as the ratio between the voltage and current at the feedpoint of the sensor, similar to a combination of the load as defined by resistance, capacitance, and inductance. The electrical properties of different materials will produce different impedances. Resonant frequencies and other properties of the sensor can also be affected.

One potential application of the present invention that has significant importance is to provide a microstrip antenna sensor package that can be utilized in the agricultural industry. In this application, the microstrip antenna sensor and accompanying sensing and transmission circuits are disposed in a sensor package about the size of a pack of gum. The sensor package contains the microstrip antenna, and possibly other sensors for measuring moisture, temperature, and salinity, a small impedance measuring circuit such as a frequency domain reflectometer (FDR) or standing wave reflectometer (SWR), a small wireless communication circuit, and a battery pack.

Ideally, the sensor package would be planted in the spring with seeds in a field. The tractor could be equipped to drop the sensor package at desired intervals so that the moisture content of the entire field could be monitored. The sensor package would be part of a sensor system that would enable automatic control of irrigation and fertilization that might be non-uniform throughout a field. The sensor system would also predict, based upon the temperatures recorded and the variety of seeds planted, when the plants are ready to be harvested. All of this information is radioed back to the farmer. A dedicated wireless antenna system could be used, or a stacked microstrip antenna could be used for gathering data and transmitting data.

The sensor system would enable efficient use of water so as to not overwater and waste resources, and to not underwater and stress the crops. This ability to wisely use water resources, especially in the west, only becomes more important during drought, when the large majority of water in a state in being applied to agriculture. Any saving of water would have a substantial impact on water reserves.

Farmers would not be the only ones who could take advantage of remote moisture sensing. The watering of residential and commercial lawns and gardens is a particularly important application of the present invention. Automatic sprinklers are notorious water wasters, watering when a lawn or garden does not need it. An automatic moisture detection system provided by the present invention would enable lawn and garden watering only when needed.

There are other industrial applications where precise moisture content is critical for optimum processing. For example, commercial composting or waste treatment need particular moisture levels in order to most efficiently perform their functions. These moisture levels could be easily monitored and kept operating most efficiently.

There are other applications where monitoring of moisture content is also important. For example, a sensor package can be disposed above ground in a snow zone. The sensor package could be used to monitor water content in the snow, and just the presence or absence of snow. This information is vital to water planners. But it should be apparent that the sensors can also be placed at various depths or locations in order to help in predicting avalanche danger.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A system for determining electrical properties of a subject material, said system comprising:
a microstrip antenna comprising:
a ground plane,
an insulating material disposed on the ground plane in a plane thereof; and
a microstrip antenna structure disposed on the insulating material; and
an impedance measuring device coupled to the microstrip antenna structure to thereby enable detection of a change of impedance of the microstrip antenna structure.

2. The system as defined in claim 1 wherein the impedance measuring device is selected from the group of impedance measuring devices comprising a network analyzer, and impedance bridge, a time domain reflectometer, and a frequency domain reflectometer.

3. A method for determining electrical properties of a subject material utilizing a microstrip antenna, said method comprising the steps of:
(1) providing a microstrip antenna and an impedance measuring device, wherein the microstrip antenna is coupled to the impedance measuring device;
(2) disposing the microstrip antenna adjacent to the subject material;
(3) measuring a change in impedance of the microstrip antenna utilizing the impedance measuring device; and
(4) correlating the change in impedance to a physical characteristic of the subject material.

4. The method as defined in claim 3 wherein the method further comprises the steps of:
(1) measuring a change in resonant frequencies of the sensor; and
(2) correlating the change in resonant frequencies with physical properties of the subject material.
